(19) United States
(12) Patent Application Publication
(10) Pub. No.: US 2018/0099347 A1
(43) Pub. Date: Apr. 12, 2018

(54) Apparatus for Improving Weld Uniformity

(71) Applicant: GM GLOBAL TECHNOLOGY OPERATIONS LLC, DETROIT, MI (US)

(72) Inventors: Huaxin Li, Rochester Hills, MI (US); David J. Paluch, Saginaw, MI (US); John Jess, Haslett, MI (US); Joel A. Fillmore, Stockbridge, MI (US)

(21) Appl. No.: 15/288,060

(22) Filed: Oct. 7, 2016

(51) Int. Cl. B23K 11/00; B23K 11/26

(52) U.S. Cl. CPC B23K 11/002; B23K 11/26

(57) ABSTRACT

An apparatus for improving weld uniformity, controlling weld spatter and reducing weld joint bending stresses. The apparatus includes a first component having a welding contact point and a second component having a weld zone for engaging with the welding contact point of the first component. At least one weld upset distance stop is formed on the first or second component operative to control weld spatter and to reduce weld joint bending stresses.

### FIELD

Apparatuses consistent with exemplary embodiments relate to apparatuses for improving weld uniformity. More particularly, apparatuses consistent with exemplary embodiments relate to apparatuses for improving weld uniformity and controlling weld spatter and reducing weld joint bending stresses.

### BACKGROUND

The statements in this section merely provide background information related to the present disclosure and may or may not constitute prior art.

Welding is a commonly known approach for joining metals. In welding, metals are caused to melt at their contact surfaces by high temperatures and, when cooled, actually fuse together at the atomic level forming a weld joint. While welding is an excellent way to join metals there are situations in which weak weld joints will fail prematurely.

Weak weld joints can result from several causes including not getting the workpieces hot enough at the contact points, residual stresses caused by rapid cooling, bending stresses at the weld joint, and lack of uniformity due to weld spatter and/or contaminants, or excessive porosity in the weld joint.

Failure of weld joints can lead to warranty losses for companies and frustration for consumers having to pay for product repair or replacement costs. It is important to development tools or processes to ensure prevention of these failures.

### SUMMARY

One or more exemplary embodiments address the above issue by providing apparatuses for improving weld uniformity. More particularly, apparatuses consistent with exemplary embodiments relate to apparatuses for improving weld uniformity and controlling weld spatter and reducing weld joint bending stresses.

According to an aspect of an exemplary embodiment, an apparatus for controlling weld spatter and bending stress between two components during a welding process includes a first component having a welding contact point. Another aspect of the exemplary embodiment includes a second component having a weld zone in communication with the welding contact point of the first component. Still another aspect as according to the exemplary embodiment includes at least one weld upset distance stop formed on the first or second component operative to control weld spatter, prevent the first component from tilting and reduce weld joint bending stress.

In accordance with other aspects of the exemplary embodiment, the welding process is a capacitor discharge welding process. Still in accordance with aspects of the exemplary embodiment, the at least one weld upset distance stop is formed lateral from either side of the weld zone.

And another aspect of the exemplary embodiment wherein the first component is a clutch hub and the second component is a shaft having a flanged end. Still another aspect of the exemplary embodiment wherein the weld zone is disposed on the flanged end of the shaft and formed to engage the weld contact point of the clutch hub. And another aspect wherein the weld contact point and the weld zone are circular.

According to another aspect of the exemplary embodiment wherein the at least one weld upset distance stop has a height greater than or equal to a predetermined height threshold. And another aspect wherein the at least one weld upset distance stop is formed at an outside diameter of the weld zone. Still further aspects of the exemplary embodiment wherein at least one weld upset distance stop is formed at an inside diameter of the weld zone and at least one weld upset distance stop is formed at an outside diameter of the weld zone.

Aspects according to still another aspect of the exemplary embodiment wherein the at least one weld upset distance stop is formed lateral to either side of the weld zone at a plurality of points.

Another embodiment of an apparatus for controlling weld spatter, weld uniformity and flatness, and bending stress between two components during a capacitor discharge welding process includes a first component having a welding contact point. Another aspect of the second exemplary embodiment includes a second component having a weld zone in communication with the welding contact point of the first component. And still another aspect of the second exemplary embodiment includes at least one weld upset distance stop formed on the first or second component operative to control weld spatter, weld uniformity and flatness and to reduce weld joint bending stress.

### BRIEF DESCRIPTION OF THE DRAWINGS

The present exemplary embodiments will be better understood from the description as set forth hereinafter, with reference to the accompanying drawings, in which:

FIG. 1 is an illustration of an exploded view of a clutch hub and a flanged shaft in accordance with an exemplary embodiment;

FIG. 1a is an illustration of an integration of a clutch hub and a flanged shaft in accordance with the exemplary embodiment;

FIG. 2 is an illustration of an enlarged view of a weld zone of a flanged shaft integrated with a weld contact point of a clutch hub in accordance with the exemplary embodiment;

FIG. 3a is an illustration of a sectional view of clutch hub and a current design of a flanged shaft with a weld zone before welding in accordance with the exemplary embodiment;

FIG. 3b is an illustration of a sectional view of clutch hub and a new design of a flanged shaft with a weld zone and at least one weld upset distance stop before welding in accordance with an exemplary embodiment;

FIG. 3c is an illustration of a sectional view of clutch hub and a new design of a flanged shaft with at least one weld upset distance stop formed on an outer diameter of a weld zone and at least one weld upset distance stop formed on an inner diameter of the weld zone before welding in accordance with exemplary embodiments;

FIG. 4a is an illustration of a sectional view of a clutch hub welded to a current design of a flanged shaft with a weld zone in accordance with an exemplary embodiment;

FIG. 4b is an illustration of a sectional view of a clutch hub welded to a new design of a flanged shaft having a weld zone and at least one weld upset distance stop in accordance with aspects of the exemplary embodiment; and

FIG. 4c is an illustration of a sectional view of a clutch hub welded to a new design of a flanged shaft with at least one weld upset distance stop formed on an outer diameter of a weld zone and at least one weld upset distance stop formed on an inner diameter of the weld zone in accordance with the exemplary embodiments.

### DETAILED DESCRIPTION OF THE INVENTION

The following description is merely exemplary in nature and is not intended to limit the present disclosure, application, or uses thereof.

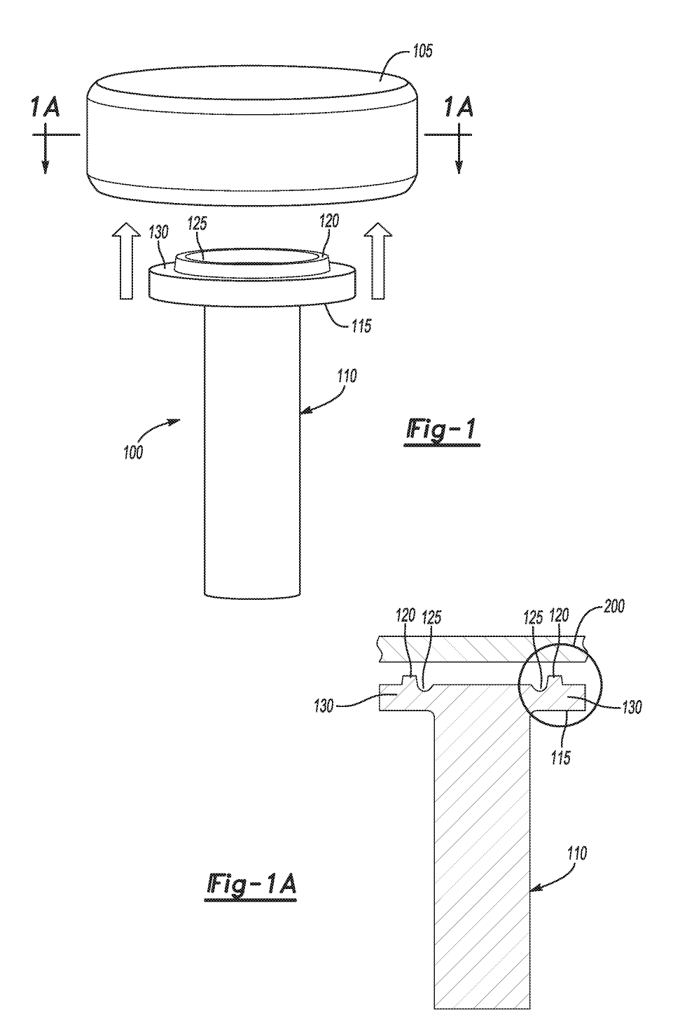

FIG. 1 provides an illustration 100 of an exploded view of a clutch hub 105 and a flanged shaft 110 in accordance with an exemplary embodiment. The flanged shaft 110 includes a flanged end 115 having a weld zone 120 concentrically formed between an inner diameter 125 and an outer diameter 130 of the flanged end 115. It is appreciated that the weld zone 120 may be formed as a continuous circle atop the flanged end 115 or as a plurality of separate weld points arranged in a manner circular fashion.

Referring to FIG. 1a, an illustration of the integration of a clutch hub 105 and a flanged shaft 110 is provided in accordance with the exemplary embodiment. The flanged end 115 of the flanged shaft 110 is formed to contact the weld contact point of the clutch hub 105 such that the weld zone 120 of the flanged shaft 110 can be interfaced with a weld contact point 122 (see FIG. 3a) of the clutch hub 105. In accordance with the exemplary embodiment, the inner diameter 125 and the outer diameter 130 of the flanged end 115 are arranged such that the inner and outer diameter surfaces of the clutch hub 105 would make contact if pressed together during assembly.

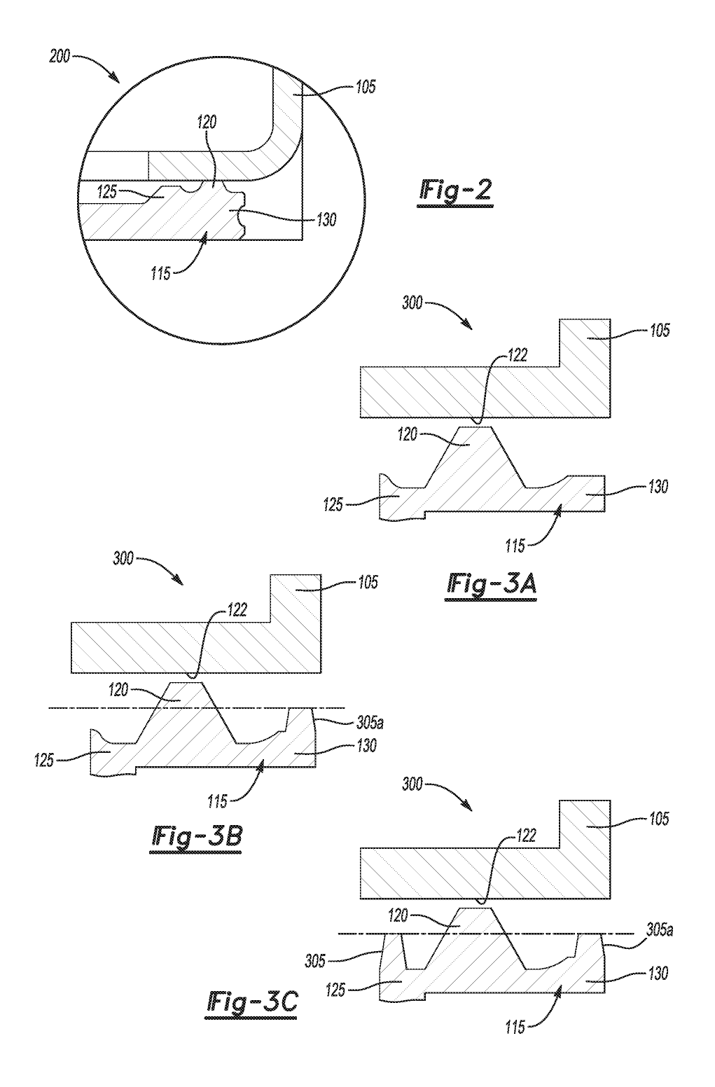

FIG. 2 is an illustration 200 of an enlarged view of a weld zone 120 of a flanged shaft 110 integrated with a weld contact point 122 of a clutch hub 105 in accordance with the exemplary embodiment. Prior to the welding process the weld zone 120 is seated in the weld contact point 122 of the clutch hub 105. As a standoff type of support, the height of the weld zone 120 prevents the inner diameter 125 and the outer diameter 130 of the flanged end 115 to make contact with the inner and outer diameters of the clutch hub 105. In this manner, the weld zone 120 may operate as a fulcrum that can allow the clutch hub 105 to pivot or tilt to either side at the weld contact point 122 prior to welding. If the clutch hub 105 becomes tilted to either side of the weld zone 120 during the welding process then the result could be a weak weld joint due to the lack uniformity in the fused material surrounding the weld contact point 122.

In such case, residual stresses between the welded materials caused by rapid cooling and/or bending stresses acting on the non-uniform weld joint and heat affected zone may lead to weld joint cracking or joint fracture that require repair. Further, a non-uniform weld joint can reduce the effectiveness of post weld tempering performed to reduce the hardness of the weld zone. Heat is distributed unevenly into a non-uniform weld joint resulting in uneven tempering which may lead to the weld joint being much more brittle in some points than others. Thus, it is important to ensure that the clutch hub 105 is properly supported by the weld zone 120 at the weld contact point 122 such that non-uniform weld joints can be avoided.

Referring to FIG. 3a, an illustration of a sectional view of clutch hub 105 and a current design of a flanged shaft 110 with a weld zone 120 before the welding process is provided in accordance with the exemplary embodiment. The clutch hub 105 includes a weld contact point 122 that is formed to receive a portion of the weld zone 120 for support during the welding process. However, ft is appreciated that the support provided by the weld zone 120 does not operate to provide stability against the clutch hub 105 tilting to either side during the welding process which could result in a non-uniform weld joint. Also, when the weld zone 120 begins to melt during the welding process it is common for the molten material to spatter which can increase the chances of getting a bad weld joint that can create more work, wastes material, and cause burn injuries if the right protective gear in not worn.

FIG. 3b is an illustration of a sectional view of clutch hub 105 and a new design of a flanged shaft 110 with a weld zone 120 and at least one weld upset distance stop 305a before the welding process in accordance with an exemplary embodiment. The at least one weld upset distance stop 305a is operable to provide additional support and stability to the clutch hub 105 prior to, during, and after the welding process such that the chances of creating a bad weld joint due to tilting of the clutch hub 105 is reduced. Also, the at least one weld upset distance stop 305a operates to control and/or block the output of weld spatter during the welding process thus reducing the chance of creating a non-uniform weak weld joint and reduce chances of burn injuries occurring. It is appreciated that the at least one weld upset distance stop 305a can be disposed on the outer diameter 130 or the inner diameter 125 of the weld zone 120 on the flanged shaft 110 in accordance with the exemplary embodiments. Also, the at least one weld upset distance stop is formed at the inner diameter 125 of the flanged end 115 or the outer diameter 130 with respect to preventing uneven weld spatter. Also, in the preferred exemplary embodiment the weld upset distance stop 305a has a predetermined height less than or equal to the height of the weld zone 120. The height of the at least one weld upset distance stop 305a is predetermined such that the best attainable results for controlling weld spatter, weld uniformity and reduced weld joint residual/bending stresses are achieved.

Referring to FIG. 3c, an illustration of a sectional view of clutch hub 105 and a new design of a flanged shaft 110 with at least one weld upset distance stop 305a formed on an outer diameter 130 of a weld zone 120 and at least one weld upset distance stop 305 formed on an inner diameter 125 of the weld zone 120 before welding is provided in accordance with exemplary embodiments. In this embodiment, there is a weld upset distance stop 305 formed on the inner diameter 125 of the weld zone 120 as well as a weld upset distance stop 305a formed on the outer diameter 130 of the weld zone 120 for providing additional support and stability against the clutch hub 105 becoming tilted to either side during the welding process. Also, the additional weld upset distance stop 305 operates to prevent or stop weld spatter from causing burn injuries and non-uniform weld joints.

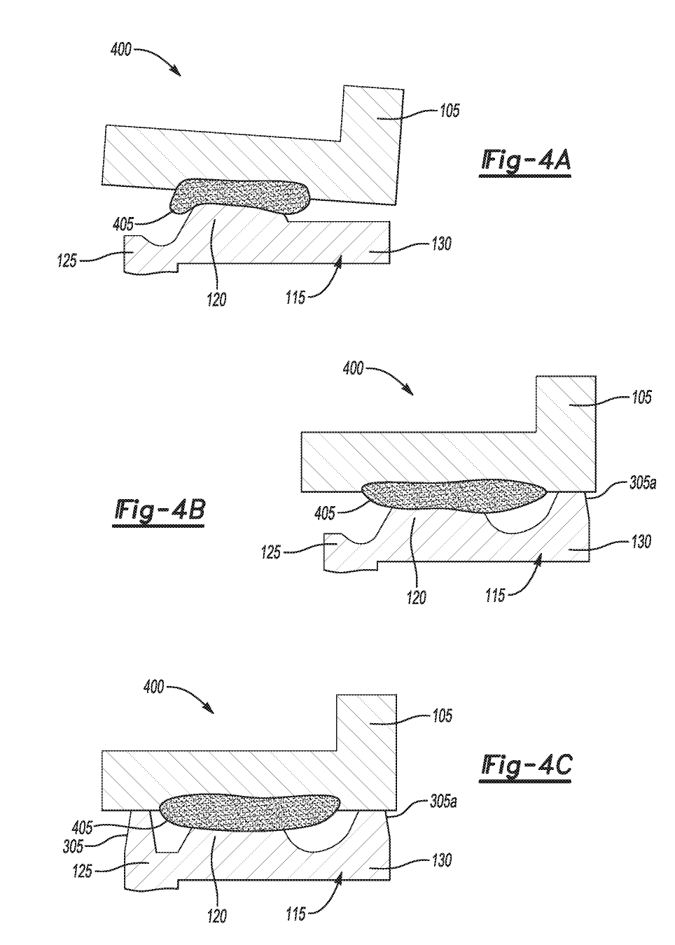

Referring now to FIG. 4a, an illustration of a sectional view of clutch hub 105 welded to a current design of a flanged shaft 110 with a weld zone 120 is provided in accordance with an exemplary embodiment. In this case, the weld joint 405 has a large size variation between sides due to the clutch hub 105 being tilted toward the outer diameter 130 of the flanged end 115 during the welding process. It is appreciated that the larger size variation of the weld joint 405 may have occurred on either side of the weld zone 120 due to the clutch hub being tilted during the welding process. This non-uniform weld joint 405 may be subjected to bending stresses which over time could result in cracking and/or fracture of the weld joint 405.

FIG. 4b provides an illustration of a sectional view of a clutch hub 105 welded to a new design of a flanged shaft 110 having a weld zone 120 and at least one weld upset distance stop 305a in accordance with aspects of the exemplary embodiment. The at least one weld upset distance stop 305a operates to support and stabilize the clutch hub 105 from tilting to the outside diameter 130 of the weld zone 120 during the welding process, in addition to blocking weld spatter and enhancing the formation of a uniform weld joint 405.

Referring now to FIG. 4c, an illustration of a sectional view of a clutch hub welded to a new design of a flanged shaft with at least one weld upset distance stop formed on an outer diameter of a weld zone and at least one weld upset distance stop formed on an inner diameter of the weld zone is provided in accordance with the exemplary embodiments. In this case, at least one weld upset distance stop 305 is formed at the inner diameter 125 of the weld zone 120 and at least one weld upset distance stop 305a is formed at the outer diameter 130 of the weld zone 120. Having weld stops (305, 305a) formed at both sides of the weld zone 120 provides optimal support and stability to prevent tilting during the welding process as well as providing a mechanism for blocking weld spatter while increasing the chances of producing a quality, uniform, and high strength weld joint 405 in accordance with the exemplary embodiments.

The description of the invention is merely exemplary in nature and variations that do not depart from the gist of the invention are intended to be within the scope of the invention. Such variations are not to be regarded as a departure from the spirit and scope of the invention.

What is claimed is:

1. An apparatus for controlling weld spatter and bending stress between two components during a welding process comprising:
a first component having a welding contact point;
a second component having a weld zone in communication with the welding contact point of the first component; and
at least one weld upset distance stop formed on the first or second component operative to control weld spatter, prevent the first component from tilting, and reduce weld joint bending stress.

2. The apparatus of claim 1 wherein the welding process is a capacitor discharge welding process.

3. The apparatus of claim 1 wherein the at least one weld upset distance stop is formed lateral from either side of the weld zone.

4. The apparatus of claim 1 wherein the first component is a clutch hub and the second component is a shaft having a flanged end.

5. The apparatus of claim 4 wherein the weld zone is disposed on the flanged end of the shaft and formed to engage the weld contact point of the clutch hub.

6. The apparatus of claim 5 wherein the weld contact point and the weld zone are circular.

7. The apparatus of claim 1 wherein the at least one weld upset distance stop has a predetermined height less than or equal to the height of the weld zone.

8. The apparatus of claim 3 wherein the at least one weld upset distance stop is formed at an outside diameter of the weld zone.

9. The apparatus of claim 3 wherein at least one weld upset distance stop is formed at an inside diameter of the weld zone and at least one weld upset distance stop is formed at an outside diameter of the weld zone.

10. The apparatus of claim 6 wherein the at least one weld upset distance stop is formed lateral to either side of the weld zone at a plurality of points.

11. An apparatus for controlling weld spatter, weld uniformity, and bending stress between two components during a capacitor discharge welding process comprising:
a first component having a welding contact point;
a second component having a weld zone in communication with the welding contact point of the first component; and
at least one weld upset distance stop formed on the first or second component operative to control weld spatter, weld uniformity and flatness, and to reduce weld joint bending stress.

12. The apparatus of claim 11 wherein the at least one weld upset distance stop is formed lateral from either side of the weld zone.

13. The apparatus of claim 11 wherein the welding contact point is on the first component.

14. The apparatus of claim 11 wherein the first component is a clutch hub and the second component is a shaft having a flanged end.

15. The apparatus of claim 14 wherein the weld zone is disposed on the flanged end of the shaft and formed to engage the weld contact point of the clutch hub.

16. The apparatus of claim 15 wherein the weld contact point and the weld zone are circular.

17. The apparatus of claim 11 wherein the at least one weld upset distance stop has a predetermined height less than or equal to the height of the weld zone.

18. The apparatus of claim 12 wherein the at least one weld upset distance stop is formed at an outside diameter of the weld zone.

19. The apparatus of claim 12 wherein at least one weld upset distance stop is formed at an inside diameter of the weld zone and at least one weld upset distance stop is formed at an outside diameter of the weld zone.

20. The apparatus of claim 15 wherein the at least one weld upset distance stop is formed lateral to either side of the weld zone at a plurality of points.
